(19) United States
(12) Patent Application Publication
(10) Pub. No.: US 2009/0165438 A1
(43) Pub. Date: Jul. 2, 2009

(54) Pulse detonation engine

(76) Inventor: Anthony C. Occhipinti, Kenner, LA (US)

Correspondence Address: ANTHONY C. OCCHIPINTI, 249 GEORGETOWN DRIVE, KENNER, LA, 70065, US

(21) Appl. No.: 12/005,200

(22) Filed: Dec. 26, 2007

(51) Int. Cl. F02C 5/00; F23C 15/00

(52) U.S. Cl. 60/247; 60/39.76; 431/1

(57) ABSTRACT

The invention provides a liquid fueled pulse detonation air breathing engine. The invention also provides an embodiment of an engine which has an axial flow compressor final stage configured for momentary closure of air flow at the final stage of the compressor followed by pulse detonation combustion that powers compressor, appliances, propeller, and produce thrust. Fuel enters the configured final stage of the axial flow air compressor to allow a mixture of air and fuel before entering the engine's pulse detonation combustion chamber, also referred to as detonation canister, having an inlet opening for receiving the fuel and air mixture charge and an open end down stream to discharge the resulting combustion products. Once the fuel and air mixture enters the detonation chamber there is closure for an instant of the compressor final stage's novel stators and blades before detonation of the fuel and air mixture. Detonation is initiated by a control system at the final compressor stage closure with ignition and impulse force is provided by a resultant shock wave. The front end of the engine allows control, and provides the use of appliances such as starter, alternator, fuel pumps, timing, and propellers if attached, as well as compressed air to the pulse detonation combustion chamber or canisters. Starting the engine is accomplished by an electrical starter motor as are conventional jet engines. Fuel is injected at the final stage of the compressor for good mixing with the compressed air before being pumped into the combustion chamber or canisters. Ignition and detonation occurs immediately downstream of the final compressor stage in the combustion chamber during the closure position of the compressor final stage. Ignition and detonation of the fuel many times a second generates shock waves that travels out of the open end of the combustion chamber or canisters at supersonic speed.

### BACKGROUND OF THE INVENTION

Scientists, researchers, engineers as well as manufacturers have been working to perfect the Humphrey cycle pulse detonation combustion engines. They have strived to bridge between the present day state of the art Brayton cycle jet engine to improved and promised the more thermal efficient pulse detonation combustion engine, with 15 to 30 percent thermal efficiency and lower NOx, together with more power and thrust. Even a thermal efficiency improvement of 0.2 percent will be a breakthrough. Many constraints have slowed progress but the future is apparent as evidenced by patents having issued for pulse detonation combustion engines such as Bussing, et al, U.S. Pat. No. 6,062,018 issued on May 16, 2000 and other publication by Jim Mathews, AIR & SPACE, Smithsonian, “Son of a Buzz Bomb”, September 2007, Vol. 22, No. 4 pp. 62-67; each are incorporated by reference along with information and reference contained therein. There has been effort concentrated on transferring gas turbine jet engine technology to pulse detonation engines, principally relying on defragative combustion and the embodiment of the conventional jet engine gas turbine. In part the present invention does rely on the above stated composition. It has a recognizable look, that is an air breathing axial flow compressor upstream of the turbine and a pulse detonation combustion chamber in the middle. It differs from the prior attempts by providing a novel design of the final stage of the axial flow air compressor that mixes the fuel with the compressed air coming off the compressor before being pumped into the pulse detonation combustion chamber, which is then valved off by the last stage compressor stators and following blades for an instant and timely ignition and detonation. The present invention avoids problems such as plumbing, normal operating appliances detached from the engines main frame; it looks like the conventional constant pressure Brayton cycle jet engine, but has the heart of the pulse detonation constant volume Humphrey cycle.

### SUMMARY OF THE INVENTION

The present invention relates to using the state of art Brayton cycle jet engine having an air breathing axial flow air compressor upstream of the combustion chamber and a turbine downstream which powers the compressor and all appliances. Significant of changes is the configured final stage of the axial flow air compressor to prevent any backflow from detonation by the momentary and timely closure of the upstream end of the combustion chamber or canisters. Having the pulse detonation combustion chamber in the middle of the engine utilizes the conventional deflagrative steady-state gas turbine more easily adopted to pulse detonation to improve combustion, increase power output, and thermal efficiency.

It is an object of the present invention is to provide a pulse detonation engine.

It is another object of the invention to provide a pulse detonation engine with significant advantages over engines in the prior art.

Also another object of the present invention to provide method to improve thermal efficiency by approximately 15 to 30 percent and lower NOx formation.

Yet another object of the invention to provide a mechanically simple method of producing clean pulse detonation combustion.

Additional objects and advantages of the invention are set forth, in part in the description which follows, and in part, will be obvious from description or may be learned by practice of the invention. The objects and advantages of the invention will be realized in detail by means of the instrumentalities and combinations particularly pointed out in the appended claims.

### BRIEF DESCRIPTION OF THE DRAWINGS

FIG. 1 shows an elevation view of the embodiment of the invention.

FIG. 2 shows a partial elevation view with an illustration of the pulse detonation chamber or canisters and a cross-section and final stage of the axial flow compressor and turbine.

FIG. 3 shows the sequence of events by the final compressor stage stator and compressor blade for full open and blocked air flow.

### DETAILED DESCRIPTION OF THE PREFERRED EMBODIMENTS

It is understood that both the foregoing general description and following detailed description are exemplary and explanatory only, and are not restrictive of the invention as claimed. The accompanying drawings which are incorporated herein for reference, and constitute part of the specifications, illustrate certain embodiments of the invention, and together with the detailed description serve to explain the principles of the present invention.

Reference will now be made in detail to several embodiments of the pulse detonation combustion system of the present invention. These examples are illustrative only and should not be construed to limit the invention unnecessarily.

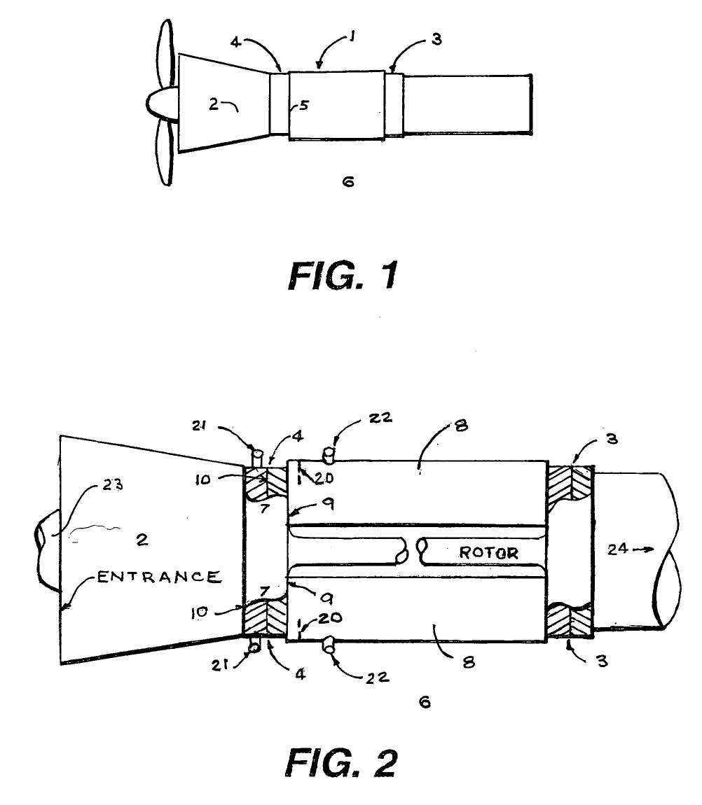

The present invention has the 1 pulse detonation chamber in the middle of the engine just downstream of the 2 axial flow air compressor, and the products of combustion flow to the downstream 3 turbine with the residual exhaust continuing out of the engine producing thrust FIG. 1. The placement of the pulse detonation combustion chamber immediately downstream of the 2 axial flow compressor can utilize the 4 final compressor stage to momentarily closing off the flow of air from the 2 compressor and any backflow at the instant of detonation FIG. 2. In effect closing off 5 one end of the combustion chamber or canister is desired for the sequence of events to take place in the 6 pulse detonation engine. (1) 7 Fuel and air are mixed; (2) The mixture is pumped into the 8 pulse detonation combustion chamber or canisters; and (3) The upstream end of the 9 combustion chamber or canisters is closed off by the compressor 4 final stage stator and compressor blade 10 blockage position for an instant, during normal rotation of the engine, at which time pulse detonation occurs. Fuel control governs the engine speed or revolution per minute (rpm) and the frequency of pulse detonations. An engine speed of 1200 rpm obtains a minimum of 20 pulse detonation per second (a pulse detonation per engine revolution), 3000 rpm obtains a minimum of 50 pulse detonation per second, and 6000 rpm obtains a minimum of 100 pulse detonations per second. It is possible to obtain the number of pulse detonations as stated for engine speed multiplied by the number of stators or blades contained in the final compressor stage.

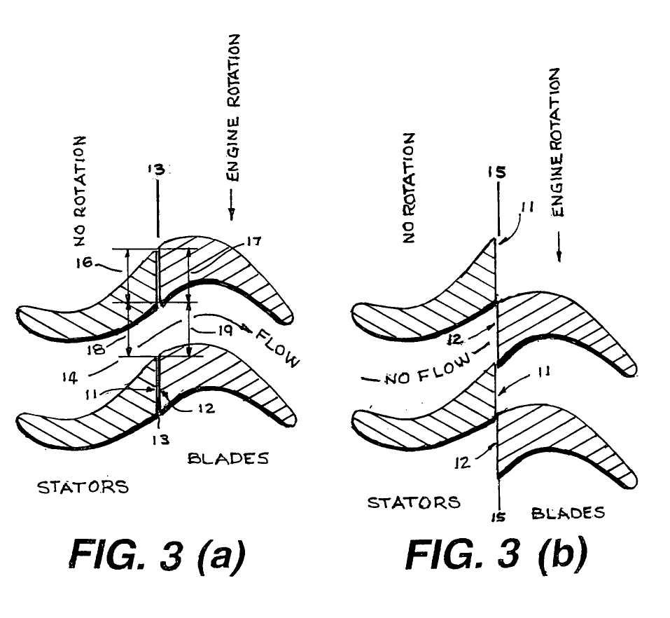

FIGS. 3 (a) and (b), show section views of the 11 trailing edge of the final stage of the compressor stator and the 12 leading edge of the compressor final stage blade. FIG. 3 (a) shows the position of the 13 stator and blade with flow, the 14 arrow indication the same; FIG. 3 (b) shows the position of the stator and blade with 15 no flow. The 16 trailing edge of the final compressor stage stator downstream of the compressor entrance, and the 17 leading edge of the final stage compressor blades are the same width; also the 18 gap between each of the final stage stators and the 19 gap between leading edge of each of the final stage blades of the compressor are the same width, and the gap between the stators and blades are the same width to facilitate momentary 15 blockage of air flow.

Pulse detonations are initiated by a control system senses the 15 position the instant of closure FIG. 3(b) with 20 a high voltage discharge electrical ignitor, and as impulse force is provided by a resultant shock wave. 21 Fuel can enter the final compressor stage at any 10 stator and blade closings. The 23 front end of the engine allows control, and provides the use of appliances such as starter, alternator, fuel pumps, timing, high voltage generator, and propellers if attached, as well as compressed air to the pulse detonation combustion chamber or canisters.

The pulse detonation may be started by the use of a conventional electrical starter motor as are jet engines. During the starting turnover of the engine good mixing results by the interaction of the final compressor stage stator and blade and with the 2 compressed air before being pumped into the combustion chamber or canisters. Ignition and detonation occurs immediately downstream of the 4 final compressor stage in the pulse detonation combustion chamber or canister during the closure position. Also downstream 15 of the final compressor stage, ignition and detonation of the fuel generates a shock wave that travels the 24 rest of the way out of the 8 combustion chamber or canisters and 3 turbine at supersonic speed, a thousand times greater than that of deflagrative combustion.

It may be convenient to use an alternant procedure for starting the pulse detonation combustion engine. It can be started in the Brayton cycle (jet engine) mode by the conventional introduction of 22 fuel directly in the 1 combustion chambers or canisters. After running briefly in this mode, a portion of the fuel volume is reduced and fuel is then injected at the 21 final stage of the compressor upstream of the combustion chamber or canisters; thereafter 22 only fuel injected in the final compressor stage is continued for operation of the pulse detonation mode.

It will be apparent to those skilled in the art that various modifications can be made in the construction and configuration of the present invention without departing from the scope or spirit of the invention. For example, the embodiments mentioned above are illustrative and explanatory only. Various changes can be made in material, detonable mixtures, as well as the configuration of the device to engineer the specific desired outcome. Thus it is intended that the present invention cover the modifications and variations of the invention, provided they come within the scope of the appended claims and their equivalents.

1. A pulse detonation engine to produce combustion products having kinetic thermal energy as a result of pulse detonation combustion consisting of detonation chamber or canisters having a fuel inlet at the configured final stage of an axial flow air compressor that pumps air into detonation combustion chamber or canisters, and a combustion chamber or canister outlet.

2. A pulse detonation engine of claim 1, further comprising a means of initiating pulse detonation in the combustion chamber or canisters during closure of flow thru the final compressor stage by the trailing edge of the final stage stator downstream of the compressor entrance, and the leading edge of the final stage compressor blades are the same width, and also the gap between each of these stators, and the gap between leading edge of each of these blades of the final stage of the compressor are the same width and the gap between the stators and blades are the same width to facilitate momentary closure to prevent any back flow during detonation.

3. A pulse detonation engine of claim 1, also having an ignitor and controlling mechanism timely igniting detonation combustion of the fuel and air mixture at closure of the final stage is provided.

4. A pulse detonation engine of claim 1, also to produce combustion products having kinetic thermal energy as a result of deflagrative combustion, comprising an engine with axial flow air compressor upstream of combustion chamber or canisters that produce deflagrative combustion products to a turbine downstream powering the compressor and other appliances by a means of furloughing a portion of the combustion chamber or canisters by cutting off a portion their direct fuel, and injecting fuel at the final compressor stage thus converting the deflagrative combustion engine mode to that of a detonation combustion engine mode; and a means of igniting the deflagration combustion chamber or canisters, and providing controls to operate both combustion modes.
